(19) United States
(12) Patent Application Publication
(10) Pub. No.: US 2011/0184863 A1
(43) Pub. Date: Jul. 28, 2011

(54) SMART ON-LINE FILING SYSTEM

(75) Inventors: Alan Coleman, Co. Dublin (IE); Jim Hannon, Co. Dublin (IE); Gus Legge, Co. Dublin (IE)

(73) Assignee: Brite:Bill, Ltd., Dublin (IE)

(21) Appl. No.: 13/016,653

(22) Filed: Jan. 28, 2011

Related U.S. Application Data
(60) Provisional application No. 61/299,115, filed on Jan. 28, 2010.

(51) Int. Cl. G06F 17/30; G06Q 40/00; G06Q 30/00

(52) U.S. Cl. 705/40; 707/827; 707/E17.01

(57) ABSTRACT

An approach is provided for enabling the assembly and delivery of documents for facilitating electronic bill payment and online document management. Collection of document information associated with a user account is performed, e.g., via a browser application. For example, the document information can include a digital scan of a physical document or an image. The collected document information is stored in a cloud-based filing system, which is configured to store a multitude of document information for respective user accounts. One or more actions are selectively initiated based on the collected document information for the particular user account.

### RELATED APPLICATIONS

This application claims the benefit of the earlier filing date under 35 U.S.C. §119(e) of U.S. Provisional Application Ser. No. 61/299,115 filed Jan. 28, 2010, entitled “Smart On-Line Filing System”; the entirety of which is incorporated by reference.

### BACKGROUND

Most people receive several forms of electronic correspondence on a daily basis, including e-mail and short simple messages (SMS). In addition, with the constant influx of physical documents such as mail, memorandums, billing statements, etc. the effort to manage documents is compounded. Consequently, service providers allow for online bill payment, paperless billing and other actionable services intended to allow customers to handle their obligations over a network (e.g., the Internet). Moreover, various data storage providers offer online document storage tools and solutions. Unfortunately, however, there is no system for seamlessly integrating document storage and bill payment solutions to enable users to manage the flow and maintenance of information. Furthermore, there is currently no means for translating physical documents of various respective formats into their electronic equivalent for facilitating the presentment and management of documents and bills via a graphical user interface.

Based on the foregoing, there is a need for effective, convenient assembly and delivery of documents for facilitating electronic bill payment and online document management.

### BRIEF DESCRIPTION OF THE DRAWINGS

The embodiments of the invention are illustrated by way of example, and not by way of limitation, in the figures of the accompanying drawings:

FIG. 1A is a diagram of a system for enabling the assembly and delivery of documents for facilitating electronic bill payment and online document management, according to one embodiment;

FIG. 1B is a diagram of an extract, transform, load (ETL) execution system of the system of FIG. 1, according to one embodiment;

FIGS. 1C-1E are flowcharts of processes for enabling the assembly and delivery of documents for facilitating electronic bill payment and online document management, according to various embodiments;

FIG. 1F is a diagram a transformation process utilized by the document management service of FIG. 1A, according to one embodiment;

FIG. 2 is a diagram depicting the process by which a user can arrange for and manage bill payments via the centralized document management service, according to one embodiment;

FIG. 3 is a ladder diagram showing a process for arranging and managing the electronic storage of correspondence and documents by way of the system of FIG. 1A, according to one embodiment;

FIG. 4 is a ladder diagram showing a process for arranging and managing mailed correspondence and documents by way of the system of FIG. 1A, according to one embodiment;

FIG. 5 is a ladder diagram showing a process for arranging and managing the storage of receipts by way of the system of FIG. 1A, according to one embodiment;

FIGS. 6A and 6B are diagrams of an exemplary graphical user interface (GUI) for providing access to services of a smart, cloud-based filing system for providing a document management service, according to various embodiments; and

FIG. 7 is a diagram of hardware that can be used to implement an embodiment of the invention.

### DESCRIPTION OF SOME EMBODIMENTS

Examples of a method, apparatus, and computer program for assembly and delivery of documents for facilitating electronic bill payment and online document management are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the various exemplary embodiments are described with respect to a document management system, electronic billing service, or the like, it is contemplated that these embodiments have applicability to any data protocols, methodologies or systems for facilitating document exchange, payment processing, online bill management, data warehousing, business intelligence and the like.

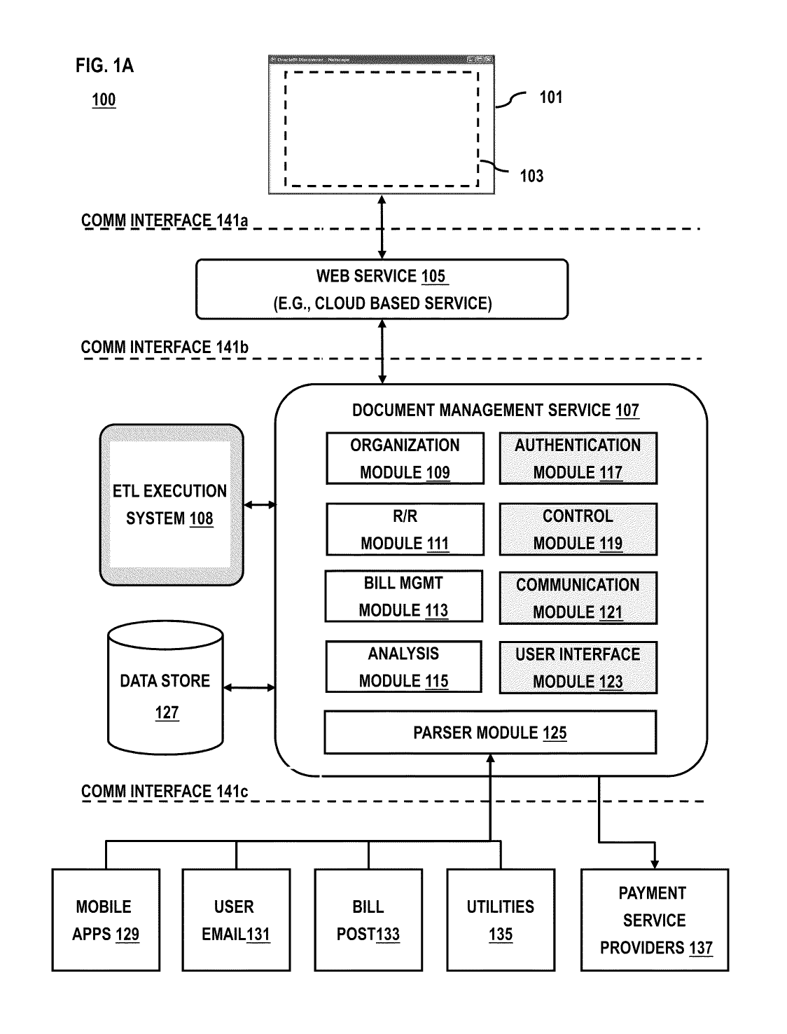

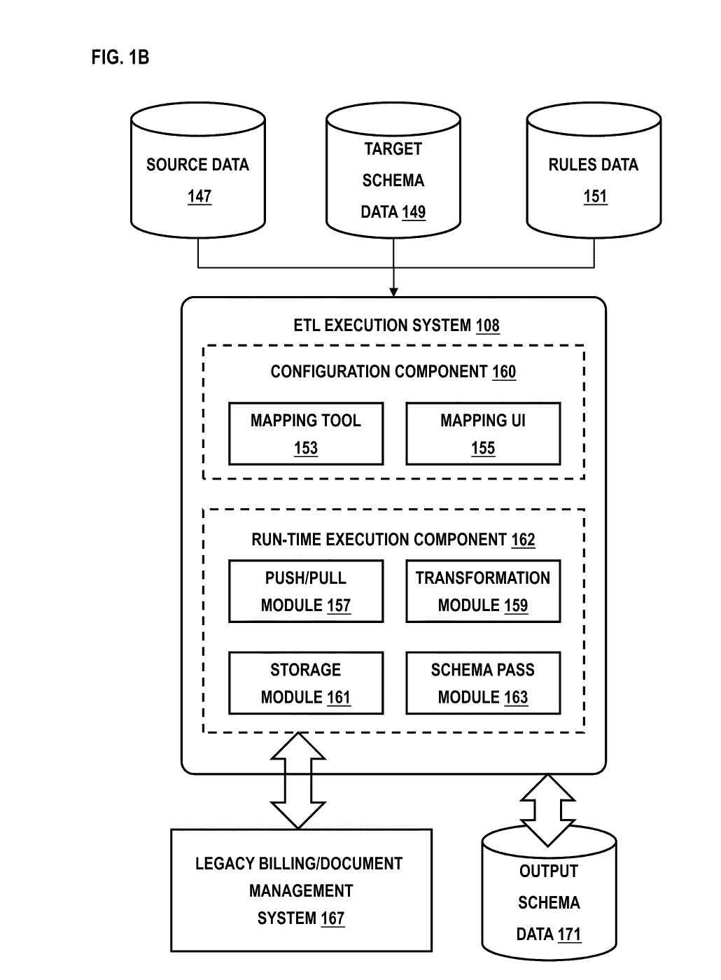

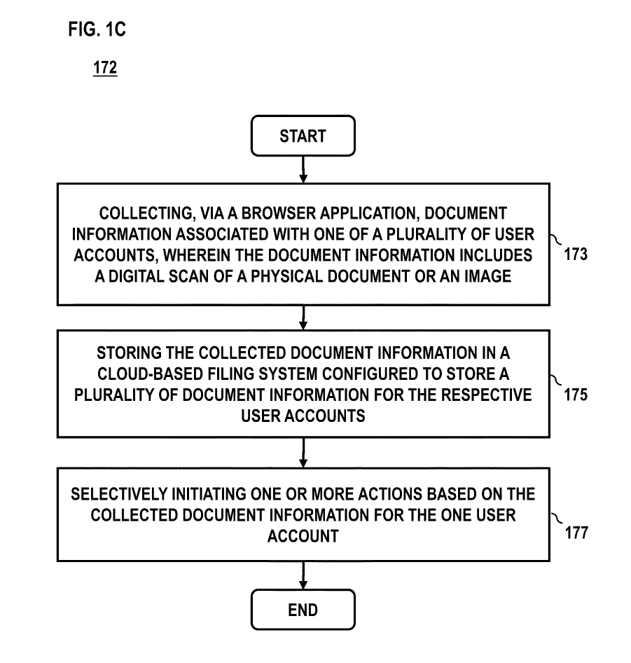

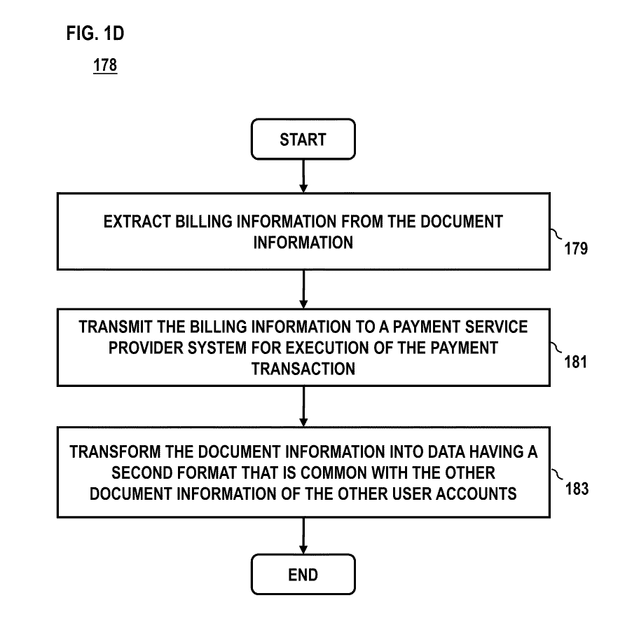

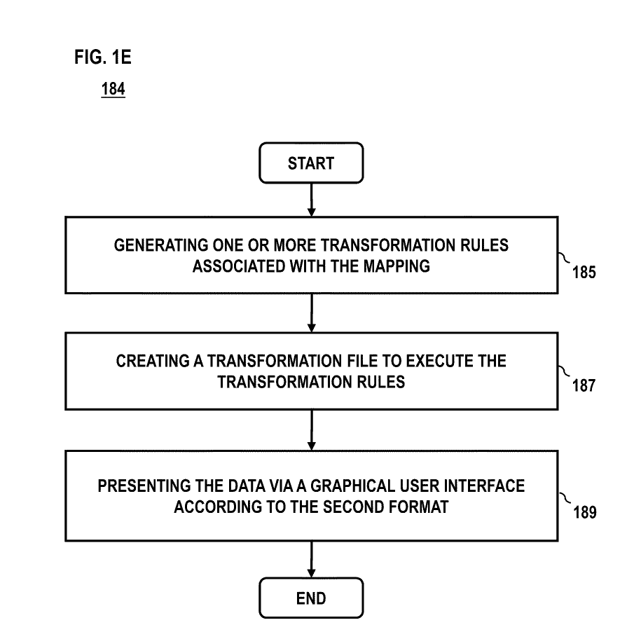

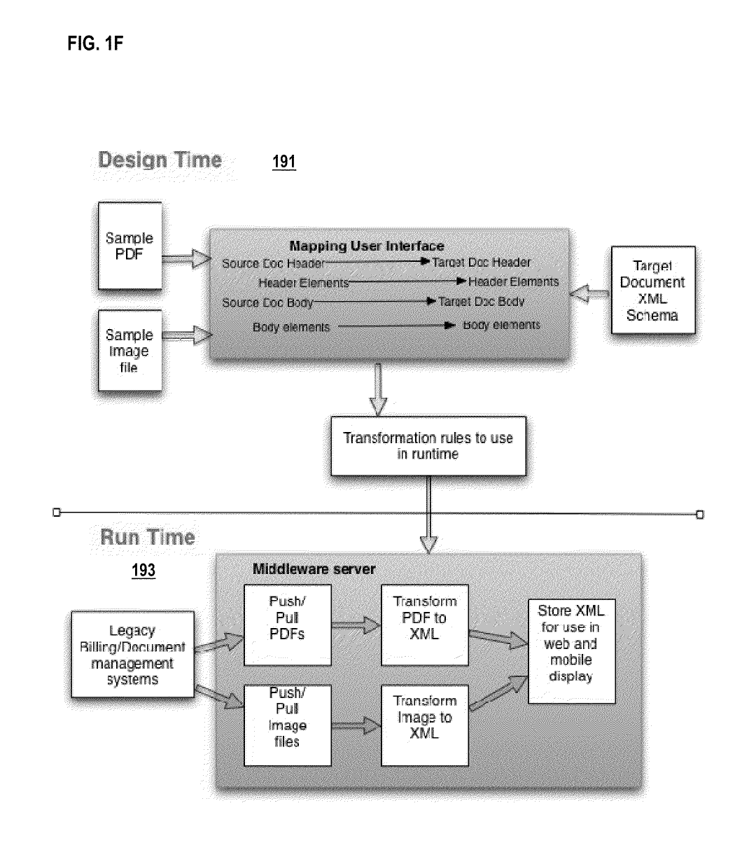

FIG. 1A is a diagram of a system for enabling the assembly and delivery of documents for facilitating electronic bill payment and online document management. As used herein, a “document” refers to any hardcopy or softcopy correspondence for conveying content 103 such as text, graphics, interactive media, graphics primitives, etc., to a user by way of a browser 101, web portal or other graphical user interface means. It is noted that documents deemed to be of particular importance to a user, referred to herein as “vital documents,” may be appropriately classified, tagged, retrieved and managed by the document management service 107. Vital documents may include bills, notices, legal correspondence, receipts, service agreements and other information.

Service providers of various types are continually challenged to deliver value and convenience to consumers by providing compelling network services and offerings to their customers. For example, most customers expect a truly informative and convenient billing relationship with their service providers. While the traditional method of sending out physical (hardcopy) billing statements is still widely used and accepted, the process of printing, assembling and delivering paper bills is time consuming, costly and resource intensive. Furthermore, with the constant influx of daily correspondence received by most customers, including e-mail, text messages and mail items, it is easy for customers to feel bombarded with information. While there are various online document storage and electronic billing solutions available, they are disjointed and do not account for all forms of documentation (hardcopy and softcopy). Furthermore, current billing and document management systems lack reliability as there is no consistent document delivery mechanism—i.e., the systems do not readily adapt to or accommodate the distinct document formats and requirements of the service provider.

To address this issue, system 100 enables personal or enterprise level users to manage, retrieve and interact with their documents over a network by way of a centralized document management service 107. In one embodiment, the system 100 includes a document management service 107 that is configured to enable users to access and maintain documents of various types from over a network. By way of example, the document management service 107 provides one or more functions and mechanisms for retrieving, storing, categorizing and managing documents with respect to a particular user account. These capabilities may be carried out via a browser 101 of any network capable user device.

It is noted that user devices may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone or any combination thereof. It is also contemplated that the user devices can support any type of interface for enabling the presentment or exchange of data. In addition, user devices may facilitate various input means for receiving and generating information, including touch screen capability, keyboard and keypad data entry, voice-based input mechanisms and the like. Any known and future implementations of user devices 101 are applicable.

In certain embodiments, the document management service 107 is configured to support electronic billing applications and services, such as to optimize the documentation processing and flow typically associated with the billing experience. By way of example, the documentation management service 107 enables enterprise level users (e.g., organizations) to generate personalized online billing offerings for their customer base. In addition, the service 107 enables billing organizations to easily adapt how and when customers view their bills, via the Internet (e.g., through use of a browser 101), mobile device, smart phone, netbook, laptop, set-top box, or any communications enabled computing device. The document management service 107 may execute one or more actions in response to presentment of a document or bill, including analysis, graphing, notification and payment options, etc.

In certain embodiments, the document management service 107 is configured to interface with one or more service providers, including a utility services provider 135, bill posting service 133, payment service provider 137 and the like. The document management service 107 interfaces with the providers in order to access the raw data needed to facilitate and support electronic billing capabilities (e.g., financial data, user account information, etc.). In addition, the document management service 107 may be configured to interface with a mobile application service provider 129 and/or email service provider 131 for enabling mobile device application support as well as for processing email correspondence. For the purpose of explanation, the providers may submit/transmit data to the service 107 in the capacity of or with respect to one or more data or document transmission/submission mediums. Data transmission/submission mediums may include, but are not limited to: a data/image capture and transmission application (e.g., a business card or receipt capture device operating on a standalone scanner, PDA, cell phone or smart phone), a user e-mail routing utility for directing or copying select user e-mail messages, a bill posting system for maintaining digital images of user selected documents of interest (e.g., as made available via a Postal Authority for a given jurisdiction) and a bill retrieval system for accessing billing or payment records (e.g., as made available by various utility companies or general service providers—i.e., online credit card access system for the user). For illustration purposes, service providers 129-137 are to be taken as functionally equivalent to, supportive of, or taken as one or more transmission/submission mediums.

All of the transmission mediums presented herein effectively enable data to be pushed (submitted to) the document management service 107, with the exception of the bill retrieval system, which generally requires the pulling (retrieval) of information from the system in accordance with user permission settings. Any means of transmitting or communicating vital documents, correspondence or data is within the scope of the embodiments herein.

In one embodiment, the document management and billing services offered by the system 100 is maintained by a service provider as a managed or hosted solution. By way of example, the document management system 107 enables any registered user of a user device to access their billing statements or other vital documents using wireless communications. For supporting this access, in one embodiment, the document management service is a smart, cloud-based system, which intelligently gathers, stores, and initiate actions for a variety of user documents, e.g., bills, etc. As used herein, “cloud-based” refers to location-independent computing, whereby shared servers (e.g., hosted) provide resources, software, and data to user devices on demand. Cloud-based applications may be implemented and accessed in the form of a web service 105 or browser application 101.

The user registers with the document service provider to establish an account, and then subsequently access the document management service 107 via a browser application (e.g., web browser 107). From the browser 101, the user may also setup or establish various settings and access features of the system. Features of the service 107—i.e., file retrieval or organization capabilities—are facilitated by way of the web service application 105 (hereafter referred to as “web service”). As is well known in the computing industry, web services 105 are useful for converting enterprise level executables into web executables. In certain embodiments, the web service 105 is implemented as one or more Application Programming Interfaces (APIs) and accessed over a network by a requesting user via the web browser 101. It is noted that the web service 105 may conform to various means of implementation.

In various embodiments, network interfaces 141a-141c are portals through which respective elements of system 100 access a communication network (not shown). The communication network may be any suitable wireline and/or wireless network, and be managed by one or more service providers. For example, the network may include an integrated services digital network (ISDN), public switched telephone network (PSTN) or other like network. In the case of a wireless network configuration, networks may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. It is further contemplated that networks may include components and facilities to provide for signaling and/or bearer communications between the various components or facilities of system 100. In this manner, they may embody or include portions of a signaling system 7 (SS7) network, or other suitable infrastructure to support control and signaling functions.

The document management service 107 includes various executable modules for performing one or more computing, data processing and network based instructions that in combination provide a means of enabling document management and electronic billing services. Such modules can be implemented in hardware, firmware, software, or a combination thereof. By way of example, the document management platform 107 may include an organization module 109, a reporting/recommendation (R/R) module 111, a bill management module 113, an analysis module 115, and authentication module 117, a control module 119, a communication module 121, a user interface module 123 and a parser module 125. In addition, the document management service 107 also interfaces with an extract, transform, load (ETL) execution system 108, which performs various functions for enabling the translation of received documents (or content information thereof) in various formats for presentment to the browser 101. It is noted that modules 109-125 provide the core intelligence of the document management service 107 for effectively processing the transmitted/submitted vital documents and interacting effectively with payment service providers 137. It is further noted that operation of these modules in conjunction with the ETL extraction system 108, and are the means through which the web service 105 may present key service features to the user via the web browser 101.

In one embodiment, the organization module 109 enables the effective grouping and/or sorting of vital documents and data within the data store in accordance with user defined rules and feature settings. The document organization module 109 also influences how the user accesses, searches and retrieves vital documents and correspondence maintained within the document management service 107. As an example, the document organization module can be used to group the user's bills, statements and documents in specific ways—i.e., group all the bills for a second home together, group all the receipts associated with a holiday together, etc. Furthermore, the organization module 109 can be used to coordinate the arrangement of documents to be viewed by the user by priority, due date, specific workflow, company name, bill type, etc.; useful for organizing the presentment of mailed correspondence that was subsequently digitized and sent to the document management service 107 provider for storage by the user.

In one embodiment, the parsing module 125 (or parser) dissects the vital documents presented to the document management service 107 from the various transmission/submission mediums, thereby determining the inherent makeup of the data within the document, contextual features, inherent data structure underlying the document, etc. Having processed the received document in this manner, the parser 125 can further translate this data into object code for effective use by the various other modules of the enterprise bus system. Well known in the industry, various types of data parsers 125 may include, but are not limited to: top-down parsers, bottom-up parsers, recursive decent parsers, LL parser (Left-to-right, Leftmost derivation), precedence parsers, BC (bounded context) parsers, CYK parsers, etc. In addition, various special interest parsers are available for use with respect to particular programming languages and methodologies, including XML parsers and JAVA parsers. Any of the aforementioned parsers are within the scope of the present embodiment. It is noted that the functionality of the parser module 125 may be further driven and/or supported by the operations of the ETL extraction system 108, which is discussed more fully later on with respect to FIG. 1B.

In one embodiment, the analysis module 115 and reporting/recommendation module 111 respectively, analyze documents and data as stored to the data store 127 and present reports and/or recommendations based on the analysis to the user. For example, the analysis module 115, at the request of the user or as defined in accordance with system settings, can analyze different billing statements to determine and report how each bill compares to previous bills (e.g., compare heating bills for December of this year to December of last year). As another example, the analysis module 115 can analyze how the user's utility consumption compares to the average (their average, company average, regional average, national average) and how their usage changes throughout the year. As yet another example, the analysis module 115 can analyze past versus present day credit card agreements, lease agreements, fee arrangements, credit reports and other vital and sensitive/contractual documents to determine any discrepancies.

As a fully scalable solution, the analysis module 115 may further integrate other executable modules that enable additional analysis capabilities for given users of the document management service 107 (e.g., for additional service fees). For example, the analysis module 115 can be integrated with a carbon calculator, which can be fed data from the dynamic document store to produce a dynamic carbon number based on the ongoing consumption of services employed by the user—i.e. power consumption, LPG (Liquefied petroleum gas) consumption, natural gas consumption, flight data/mileage accumulation, etc. As such, the carbon calculator can be utilized to provide the user with a measure (footprint) of the impact of their consumed services on the climate.

The result of any analysis performed is presented to the user by the report/recommendation module 111 in the form of various charts, graphs, textual descriptions, summary reports or the like. Reports can optionally feature a recommendation regarding the compiled metrics or findings of the analysis that can be used to guide the user in the direction of alternate service providers or additional services that may be of benefit to them. The recommendations or analysis can be featured to the user as content 103 to the browser 101. By way of example, an analysis revealing that a user consistently experiences overdraft fees can trigger an advertisement from a banking institution that doesn't charge such fees. Under this scenario, this recommendation option may be turned on or off by the user, and information may be maintained with respect to the tenets of consumer privacy policies/protections.

The analysis 115 and R/R module 111 enable users to effectively spot errors, manage utility/service usage, explore usage and consumption patterns and more accurately plan household budgets. As noted, reports can be presented to the user via the web browser 101, or alternatively, sent to the user as a text alert, e-mail report or attachment (e.g., PDF). In addition to reporting, the R/R module 111 may further inform how the web service 105 manages the presentment and execution of data/queries pursuant to the preferences, features or settings of the user.

In one embodiment, the billing management module 113 facilitates the exchange of bill payment/subscription payment information with one or more payment service providers 137 so as to enable convenient paperless billing and bill payment services. By way of example, for users who have not previously established paperless billing via their service provider, the billing management module 113 coordinates the service on the users behalf (e.g., online credit card bill payment, utility bill payment, cell phone service payment), ensuring the direction of electronic correspondence for said service provider 137 is directed to the document management service 107 account related to the user. In this way, billing statements and other vital documents and/or correspondence between the user and service provider are conveniently stored for the user to the data store. It is noted that the bill management module may operate in conjunction with an authentication module 117.

As yet another execution, the billing management module 113 may operate in connection with the organization module 109 and/or analysis module 115 to automatically analyze incoming bills and statements to determine payment due dates, and subsequently add these dates to an online/virtual payment calendar. The reporting/recommendation module 111 can then send the user timely payment reminders by email and/or text message based on the determined payment due dates.

In another embodiment, the billing management module 115 facilitates the conversion of mailed correspondence for access via the document management service. In this scheme, the user may have select documents directed to the document management service 107 provider, wherein they are automatically digitized for inclusion/access via the document management service. The ETL execution system 108 is relied upon for developing a schema that enables consistent, rules-based processing of the documents by the billing management module 115; so as to ensure maintenance of integral document features including logos, graphics, content features, etc.

In one embodiment, the authentication module 117 authenticates users and user devices for interaction with the document management service 107. By way of example, the authentication module 117 receives a request to subscribe to the document management service 107 for enabling document management, document delivery and integrated electronic billing services. The subscription process may include enabling various user settings or preferences, including preferred content information 103 presentment settings, update or refresh settings, data organizational settings (e.g., for guiding execution of the organization module 109), login and password settings, document management service 107 level and payment settings, etc. Preferences and settings information is referenced to a specific user, user device, or combination thereof, and maintained as profile data to the data store 127.

The authentication process performed by the module 117 may also include receiving and validating a login name and/or user identification value as provided or established for a particular user during a subscription or registration process with the service provider. The login name and/or user identification value may be received as input provided by the user from their user device or other device via a graphical user interface to the service 107 (e.g., as enabled by a user interface module 215). Registration data (as maintained in data store 127) for respective subscribers, containing pertinent user or device profile data, may be cross referenced as part of the login process. Alternatively, the login process may be performed through automated association of profile settings maintained as registration or profile data with an IP address, a carrier detection signal of a user device, mobile directory number (MDN), subscriber identity module (SIM) (e.g., of a SIM card), radio frequency identifier (RFID) tag or other identifier. Still further, the authentication module 117 may also be configured to receive requests from various devices for activation of a specific feature of the document management service 107.

In one embodiment, a communication module 121 enables formation of a session over a communication network 109 between the service 107 and the browser application 101, the various transmission/submission mediums 129-137, the web service 105 or the ETL extraction system 108. By way of example, the communication module 121 executes various protocols and data sharing techniques for enabling collaborative execution between a subscriber's user device (e.g., mobile devices, laptops, smartphones, tablet computers, desktop computers) and the data management service 107 over a communication network by way of one or more communication interfaces 141a-141c. It is noted that the communication module 121 is also configured to support a browser session—i.e., the retrieval of content as referenced by a resource identifier during a specific period of time or usage of the browser 101. The browser session may support execution of a bill payment, document management, internet search, web page upload, multimedia playback and other functions.

Also, in one embodiment, a control module 119 is configured to regulate the communication processes between the various other modules for facilitating electronic bill payment and online document management. For example, the control module 119 generates the appropriate signals to control the communication module 121 for facilitating transmission of data over a network by way of a communication interface 141. Also, while not shown, the controller module 121 may access various monitoring systems for regulating operation of the data management service 107. This may include systems for detecting current data traffic levels, error conditions, data exchange rates, network latencies, resource allocation levels and other conditions associated with the operation of the service 107, such as to ensure its effective use respective to a browser application 101.

Also, while not shown, various monitoring systems may be accessed by document management service 107 for detecting current data traffic levels, error conditions, data exchange rates, network latencies, resource allocation levels and other conditions associated with the operation of the service 107. Hence, the monitoring systems may provide feedback data to the service 107 for enabling regulation of, and seamless execution of, its various features. It is noted that modules 109-125 may interact with one another to provide an integrated suite of capabilities, features and options to the user. Rather than just bill payment, the document management service 107 provides several integral executables for enabling a centralized document management experience.

FIG. 1B is a diagram of an extract, transform, load (ETL) execution system of the system of FIG. 1, according to one embodiment. The ETL execution system 108 is comprised of various components 160 and 162 for performing one or more computing, data processing and network based instructions that in combination provide a means of enabling the translation of received documents (or content information thereof), provided as source data 147 in various formats, for presentment to the browser 101. The ETL execution system 108 also supports the generation of document schema 149 and rules data 151 for supporting operation of the various modules of the document management service 107. By way of example, the components of the ETL execution system 108 include a configuration component 160 and a run-time execution component 162.

In one embodiment, the configuration component 160 provides tools for configuring the document management service 107 to handle transmission/submission mediums of various types and documents conforming to various designs/formats. For example, a mapping tool 153 maps source data 147, such as a sample PDF, image file or other document, to a target document that is representative of the document to be created. The source data 147 includes various components, including a document header and associated header elements, a document body and associated body elements, etc. By way of the mapping tool, the components of the source data 147 may be mapped or referenced to the target document, which is defined in accordance with a markup language (e.g., extensible markup language) or other schema data 149. It is noted that mapping tools 153 enable selective or associative correlation between data elements of the source and target; the affinity between respective elements being useful for enabling pattern, format or content recognition details (e.g., rules data 151) that is implementable and conveyed in part based on the target schema data 149.

For example, the document header and associated header elements of the source data (e.g., a sample document to be mapped) may be directly mapped to corresponding document header and associated header elements of the target document. Likewise, the document body and associated body elements of the source data 147 may be directly mapped to corresponding document body and associated body elements of the target document. It is noted that the mapping procedure may be executed manually, such as in connection with a mapping user interface 155 of the mapping tool 153. Alternatively, the process may be performed on an automated basis, such as by way of a mapping selection process or algorithm. The above described process is suitable for facilitating training of the document management system 107 to recognize and handle subsequent instances of a given document, such as provided for the first time by a service provider (on first time loading). Furthermore, rules data 151 is generated by, or derived by, the mapping tool 153 for indicating transformation rules associated with the mapping.

In one embodiment, the mapping tool 153 generates the rules data 151 based, at least in part, on one or more user defined rules and feature settings. Under this scenario, rules data 151 is further generated and/or derived based on features set forth by the user, the document, an operating system, or a combination thereof; said features being suitable for controlling or affecting the user experience as they interact with the document/document management service 107. Generally, such settings may be established by the user at the time of account activation or alternatively, modified at any time the account is active. The various user defined features and settings of the document management service may include the following, as shown in Table 1:

TABLE 1
USER DEFINED FEATURES:
Automatic billing report generation (e.g., leveraging the report
generation module)
Custom document organization, grouping and retrieval (e.g., leveraging
the document organization module)
Historical versus present day bill analysis (leveraging the document
analysis module)
Virtual bill payment calendar (e.g., leveraging the document analysis,
organization and billing management modules)
Alert/Notifications-i.e., licensing renewal notification, payment due
dates, contract deadlines, etc. (e.g., leveraging all modules)
USER DEFINED RULES:
Report types, format and frequency
Document retrieval, organization and sorting
Analysis types, scope, time frames, objectives and data elements of
interest
Alert/Notification types and frequency
Bill payment management types, options, service provider settings, etc.
E-mail account setup, user login settings, redirect settings, POP settings

As used herein, “user defined” refers to the ability of the user to select from a menu of system provided features, such as from a settings link via the web browser 107 for enabling some of the above described executions (e.g., frequency options=monthly, weekly, daily). The features and settings established by the user determine which specific executions are called upon by the web service as it brokers the desired versus available document management service executions. Furthermore, these elements may be incorporated into the rules data 151 and schema data 149, such as to enable dynamic and actionable content execution upon the document being rendered to the browser 101 by the web service 105.

Once the rules data 151 is created, it is made available for use by the run-time execution component 162 of the ETL execution system 108. The run-time execution component 162 executes the rules data 151 when a file corresponding to the given type and filename pattern is pushed or pulled by a push/pull module 157. By way of example, the documents may be provided by the various transmission/submission mediums 129-135, a legacy billing/document management system 167, or a combination thereof.

In one embodiment, a transformation module 159 processes the supplied documents (e.g., incoming billing statements related to a particular user account) using the transformation rules data 151. By way of example, the transformation rules data 151 is used to map input PDF, image and other files of varying types and formats to a corresponding output PDF, image, etc. in accordance with markup language or other schema format (e.g., XML). The generated output is stored by a storage module 161 as output schema data 171. The schema data 171 is then passed to the document management service 107 by a schema pass module 163. It is noted that the document management service 107 generates a hypertext based display of the document (e.g., bills), based on the output schema 171, for display via the browser 101.

Of note, the ETL execution system 108 extracts data from legacy file formats and transforms the data into a well defined, XML taxonomy. The XML taxonomy is fashioned to support all types of postal mail and other hardcopy documents. An exemplary XML taxonomy is provided below in Table 2. The operation of the ETL execution system 108, by way of example, is further explained below with respect to FIGS. 1C-1E.

FIGS. 1C-1E are flowcharts of processes for enabling the assembly and delivery of documents for facilitating electronic bill payment and online document management, according to various embodiments. For the purpose of illustration, the processes are described with respect to the systems of FIGS. 1A and 1B. It is noted that the steps of these processes may be performed in any suitable order, as well as combined or separated in any suitable manner.

In process 172 (FIG. 1C), collection of document information associated with a user account is performed, e.g., via a browser application (per step 173). For example, the document information can include a digital scan of a physical document or an image. In step 175, the process 172 stores the collected document information in a cloud-based filing system (e.g., cloud based service 105), which is configured to store a multitude of document information for respective user accounts. Next, in step 177, the process 172 selectively initiates one or more actions based on the collected document information for the particular user account. According to certain embodiments, the actions include a payment transaction or other financial transactions.

Assuming the action is a payment transaction, as seen in FIG. 1D, process 178 involves extracting billing information from the document information, per step 179. The billing information is then transmitted, as in step 181, to a payment service provider system (e.g., payment service provider 137) for execution of the payment transaction. In step 183, the document information is transformed into data having a second format that is common with the other document information of the other user accounts. In one embodiment, the second format includes an extensible mark-up language (XML) format. Also, the transformation can be performed via a mapping user interface that maps one or more source fields into one or more target fields. The source fields, according to one embodiment, includes a document header field and a document body field.

As depicted in FIG. 1E, process 184 provides for the generation of one or more transformation rules associated with the mapping (step 185). In step 187, a transformation file is created to execute the transformation rules. Thereafter, the data is presented, e.g., via a graphical user interface according to the second format (e.g., XML format), as in step 189.

The described processes 172, 174, and 178 are illustrated in FIG. 1F in which these processes are viewed as part of a design time scenario 191 and run time scenario 193. As seen in FIG. 1C, the

At design time, the user (e.g., configuration engineer) can load the source PDF's/Images and target XML schema into a user interface. The PDF/Image document is parsed and all data fields are presented on the UI in a “Source” document tree.

By way of example, Table 2 provides an exemplary XML taxonomy:

```
TABLE 2
<?xml version=“1.0” encoding=“UTF-8”?>
<schema xmlns=“http://www.w3.org/2001/XMLSchema”
targetNamespace=“http://www.britebill.com/edoc/Electronicbiller”
xmlns:edoc=“http://www.britebill.com/edoc/Electronicbiller”>
  <include schemaLocation=“electronicdoctypes.xsd” />
  <complexType name=“ElectronicDocument” abstract=“true”>
      <sequence>
        <element maxOccurs=“1” name=“Category”
type=“edoc:Category” />
        <element maxOccurs=“1” name=“IssueDate”
type=“edoc:IssueDate” />
        <element maxOccurs=“1” name=“RecipientName”
type=“edoc:ReceipientName” />
        <element maxOccurs=“1” name=“RecipientAddress”
type=“edoc:Address” />
        <element maxOccurs=“1” name=“SenderName”
type=“edoc:SenderName” />
        <element maxOccurs=“1” name=“SenderAddress”
type=“edoc:Address” />
        <element maxOccurs=“1” name=“DocumentURL”
type=“edoc:DocumentURL” />
        </sequence>
    </complexType>
    <complexType name=“Bill” abstract=“true”>
        <complexContent>
            <extension base=“edoc:ElectronicDocument”>
                  <sequence>
                      <element name=“accountId”
type=“edoc:AccountId” />
                      <element name=“amount”
type=“edoc:BillAmount”
/>
                      <element name=“previousamount”
type=“edoc:BillAmount” />
                      <element name=“previousbalance”
type=“edoc:BillAmount” />
                      <element name=“duedate” type=“date” />
                      <element name=“biller”
type=“edoc:BillerName”
/>
                        <element name=“billId”
type=“edoc:BillId” />
                        <element name=“billerTaxNumber”
type=“edoc:TaxNumber” />
                        <element name=“paymentMethod”
type=“edoc:PaymentMethod” />
                        <element name=“paymentStatus”
type=“edoc:PaymentStatus” />
                        <element name=“billPeriodFrom”
type=“date” />
                        <element name=“billPeriodTo”
type=“date” />
                        <element name=“summaryPayments”
type=“edoc:SummaryPayments” />
              <element name=“billItems”
type=“edoc:BillItems” />
                    </sequence>
                </extension>
              </complexContent>
        </complexType>
        <element name=“Service” type=“edoc:ServiceType”
abstract=“true”>
        </element>
            <complexType name=“ServiceType” abstract=“true”>
                <complexContent>
                    <extension base=“edoc:Bill”>
                      <sequence>
                            <element maxOccurs=“1”
name=“SupplyAddress”
type=“edoc:Address” />
                  </sequence>
              </extension>
            </complexContent>
        </complexType>
        <complexType name=“EnergyServiceType”>
              <complexContent>
                  <extension base=“edoc:ServiceType”>
                      <sequence>
                          <element maxOccurs=“1” name=
                          “MeterId”
type=“edoc:MeterId” />
                          <element maxOccurs=“1”
name=“MeterReadingPrevious”
type=“edoc:ElectricityBillMeterReading”
/>
                          <element maxOccurs=“1”
name=“MeterReadingPresent”
type=“edoc:ElectricityBillMeterReading”
/>
                        <element maxOccurs=“1”
name=“MeterReadingType”
type=“edoc:ElectricityBillMeterReadingType” />
              </sequence>
              </extension>
            </complexContent>
            </complexType>
            <complexType name=“TelecomsServiceType”>
              <complexContent>
                  <extension base=“edoc:ServiceType”>
                    <sequence>
                    <element maxOccurs=“1” name=“RentalFrom”
type=“date” />
                    <element maxOccurs=“1” name=“CallsTo”
type=“date” />
                    <element name=“call”
type=“edoc:CallData” />
                    </sequence>
                    </extension>
              </complexContent>
            </complexType>
            <element name=“EnergyService”
type=“edoc:EnergyServiceType”
substitutionGroup=“edoc:Service”></element>
            <element name=“TelecomsService”
type=“edoc:TelecomsServiceType”
substitutionGroup=“edoc:Service”></element>
            <complexType name=“SummaryPayments”>
              <sequence>
                  <element name=“balanceForward”
type=“edoc:Amount” />
                  <element name=“amountDue” type=“edoc:Amount”
/>
                  <element name=“summaryPayment”
                  minOccurs=“1”
maxOccurs=“unbounded”>
                  <complexType>
                    <sequence>
                        <element name=“Description”
type=“string” />
                        <element name=“Date” type=“date” />
                        <element name=“Amount”
type=“edoc:Amount” />
                    </sequence>
                  </complexType>
                        </element>
                    </sequence>
                  </complexType>
                  <complexType name=“BillItems”>
                    <sequence>
                        <element name=“billItem” minOccurs=“1”
maxOccurs=“unbounded”>
                    <complexType>
                        <sequence>
                          <element name=“Date” type=“date” />
                          <element name=“Category”
type=“string”
/>
                          <element name=“Description”
type=“string” />
                          <element name=“Quantity”
type=“integer”
/>
                          <element name=“UnitRate”
type=“decimal”
/>
                          <element name=“TaxRate”
type=“decimal”
/>
                          <element name=“TaxAmount”
type=“decimal”
/>
                          <element name=“AmountWithTax”
type=“edoc:Amount” />
                          <element name=“AmountExTax”
type=“edoc:Amount” />
                          </sequence>
                </complexType>
              </element>
            </sequence>
        </complexType>
        <complexType name=“CallData”>
              <sequence>
                <element name=“callData” minOccurs=“1”
maxOccurs=“unbounded”>
                  <complexType>
                    <sequence>
                        <element name=“Date” type=“date” />
                        <element name=“Category” type=“string”
/>
                        <element name=“Description1”
type=“string” />
                        <element name=“PhoneNumber”
type=“edoc:PhoneNumber” />
                        <element name=“Duration”
type=“decimal”
/>
                        <element name=“UnitRate”
type=“decimal”
/>
                        <element name=“Cost”
type=“edoc:Amount”
/>
                      </sequence>
                  </complexType>
                </element>
                </sequence>
            </complexType>
            <complexType name=“PaymentReceived”>
          <sequence>
                <element name=“Description” type=“string” />
                <element name=“Date” type=“date” />
                <element name=“Amount” type=
                “edoc:MoneyValue” />
          </sequence>
        </complexType>
</schema>
```

The Target tree can be represented by an XML schema that defines the output document structure. The user can graphically map source data fields to target fields, each mapping creates rules in a “Transformation” file. The transformation file is deployed, e.g., a runtime server, and can be loaded by a runtime transformation engine when a file of the given type and filename pattern is pushed or pulled into the runtime workflow. The transformation file rules are then used to map input PDF and Image files to output XML files. These XML files may then be used to display HTML representations of bills or invoices, to display on mobile devices or an input dataset to reports and analysis.

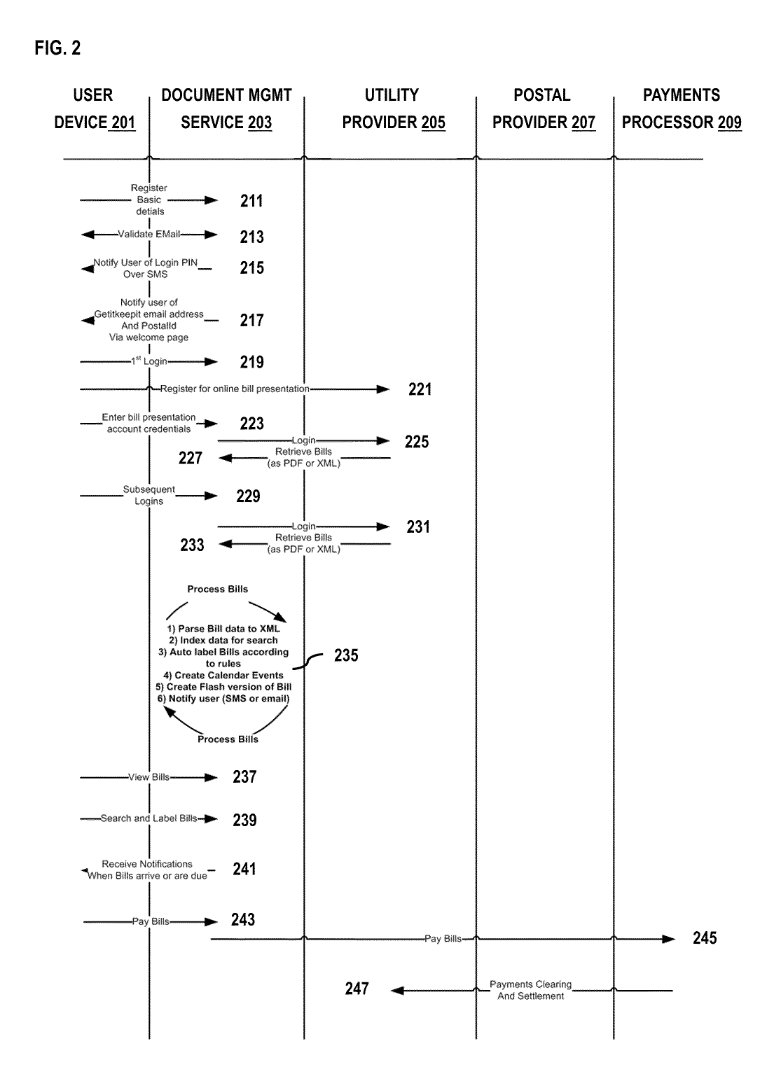

The above processes 172, 174, and 178 can be performed at various stages in processes of FIG. 2-5.

FIG. 2 is a diagram depicting the process by which a user can arrange for and manage bill payments via the centralized document management service, according to one embodiment. By way of example, the diagram presents the sequential workflow that occurs between the various elements of system 100 for enabling effective bill management. These include at least the document management service 203, a user device 201 and one or more transmission/submission mediums including a utility service provider 205, postal service provider (postal authority) 207 and the payments processor 209. The process is as follows: a user device 201 registers with the document management service 203 and provides basic details (event 211); registration is validated by e-mail (account established) (event 213); document management service notifies the user of the appointed e-mail address that should be used to direct electronic correspondence as well as the associated postal identification via a welcome page (events 215-217).

Upon first login by the user (event 219), the user registers for online bill payment via the document management service 203 with the utility service provider 205 (event 221). This includes entering bill presentation account credentials via the document management service (event 223); logging into the utility service provider's system (event 225); retrieving (pulling) billing statements (e.g., as PDF or XML) (event 227); and subsequent logins (events 229-233). Upon retrieval, the bills are processed as follows: 1) parse bill data to XML, 2) index data for search, 3) auto label bills according to rules, 4) create calendar events, 5) create flash version of bill (for user presentment), 6) notify user of processing (e-mail, SMS/text) (events 235). This process will repeat for all bills retrieved.

The user can then login to view the retrieved bills, search and label bills, receive notifications when bills arrive or are due or pay bills via the document management service (events 237-243). Bill payments are relayed to the payment service provider (event 245), and subsequent payment clearance and settlement notifications are forwarded from the payment service provider to the document management service (event 247).

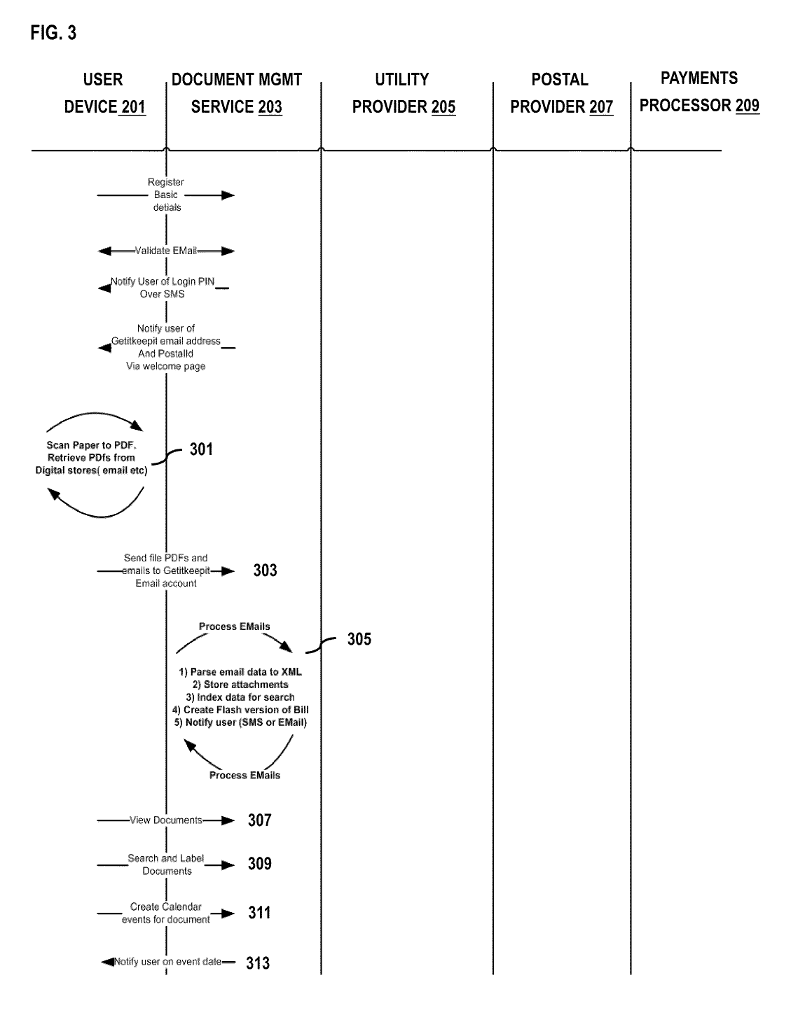

FIG. 3 is a ladder diagram showing a process for arranging and managing the electronic storage of correspondence and documents by way of the system of FIG. 1, according to one embodiment. Similar to FIG. 2, the diagram presents the sequential flow that occurs between the various entities/parties associated with the user, but in this case for ensuring effective document management. Beyond the registration process, as already discussed in FIG. 2, the process is as follows: user device scans/images a vital document of interest and converts it to an image based document format, including but not limited to PDF (event 301); alternatively, the user retrieves existing PDFs from a user data store (e.g., on the user's local computer). The user sends the PDFs via e-mail to the document management service (event 303), where the PDFs are processed as follows: 1) parse email data to XML, 2) store attachments, 3) index data for search, 4) create flash version of document (for user presentment), 5) notify user of processing (e-mail, SMS/text) (event 305). This process will repeat for all processed emails received.

The user can then login to view the documents, search and label documents, create calendar events pertaining to the document, analyze the document, share the document with select recipients, etc (events 307-311). For any scheduled events on the calendar, the user will be notified on or in advance of the event date via user established reminder settings (event 313).

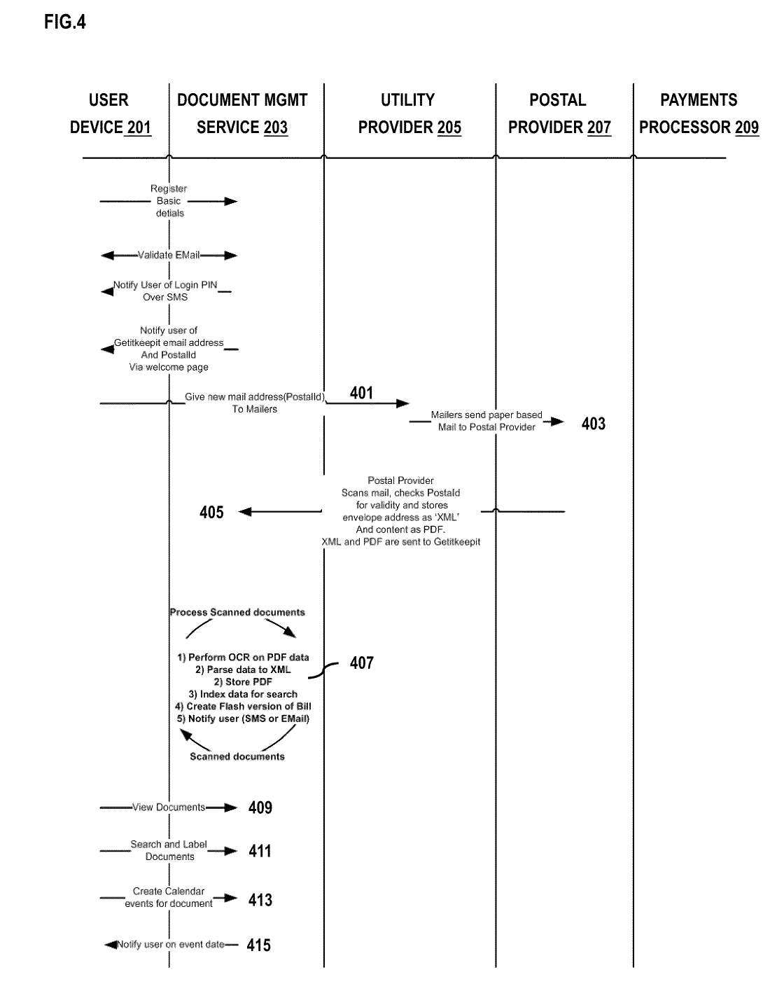

FIG. 4 is a ladder diagram showing a process for arranging and managing mailed correspondence and documents by way of the system of FIG. 1, according to one embodiment. Similar to FIGS. 2-3, the diagram presents the sequential flow that occurs between the various entities/parties associated with the user, but in this case for ensuring effective mailed correspondence/document management. Beyond the point of registration, the process is as follows: user device gives the assigned postal identification to mailers of interest (event 401); mailers then forward mail to the postal authority based on the provided postal identifier (event 403). Once received, the postal authority then scans the mail accordingly, validates the postal identifier, stores the envelope address as XML and content of the correspondence as PDF; the XML and PDF are then sent to the document management service (e.g., via e-mail) (event 405).

Once received, the document management service processes the document as follows: 1) perform OCR on the PDF data, 2) parse bill data to XML, 3) store PDF, 4) index data for search, 5) notify user of processing (e-mail, SMS/text). This process will repeat for all processed emails received (event 407).

The user can then login to view the documents, search and label documents, create calendar events pertaining to the document, analyze the documents, share the document with select recipients, etc (events 409-413). For any scheduled events on the calendar, the user will be notified on or in advance of the event date via user established reminder settings (event 415). The above described process enables the user to employ the document management service as a virtual PO Box.

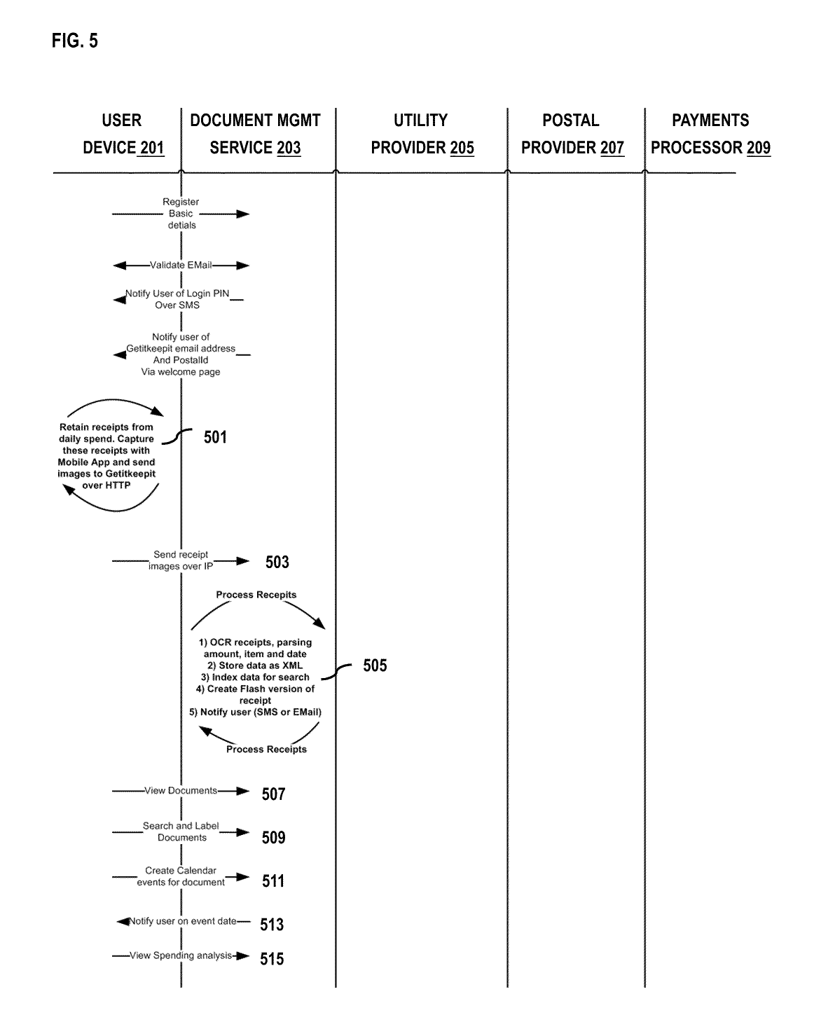

FIG. 5 is a ladder diagram showing a process for arranging and managing the storage of receipts by way of the system of FIG. 1, according to one embodiment. Beyond the point of registration, the process is as follows: user device scans/images a vital document of interest using a mobile application (event 501); the mobile application captures the vital document of interest (e.g., receipt), and sends the image to the document management service via HTTP (event 503). Upon receipt, the document management service processes the receipts as follows: 1) OCR receipts, parsing amount, item and data, 2) store data as XML, 3) Index data for search, 4) create flash version of receipt, 6) notify user of processing (e-mail, SMS/text). This process will repeat for all processed emails received (event 505).

The user can then login to view the documents, search and label documents, create calendar events pertaining to the document, analyze the document (e.g., view spending analysis), share the document with select recipients, etc (events 507-515). For any scheduled events on the calendar, the user will be notified on or in advance of the event date via user established reminder settings.

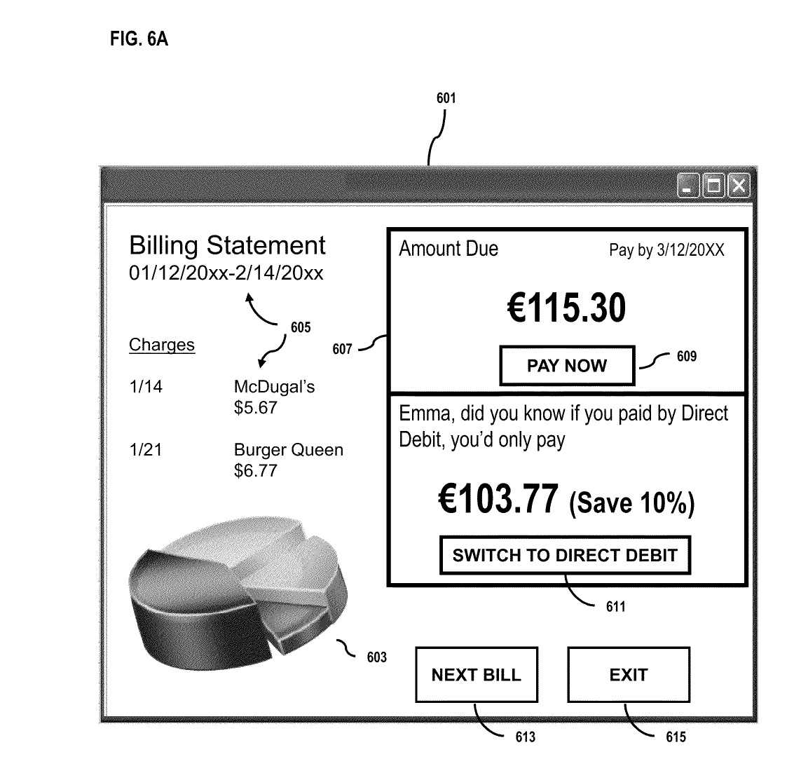

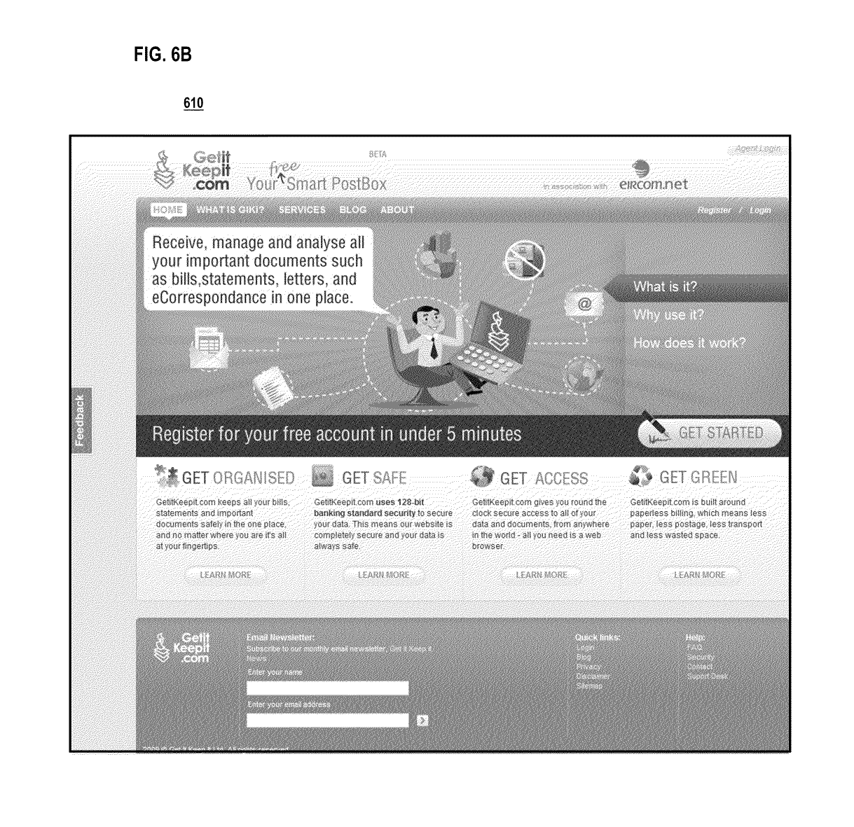

FIGS. 6A and 6B are diagrams of exemplary graphical user interface (GUI) for providing access to services of a smart, cloud-based filing system for providing a document management service, according to various embodiments. By way of example, the document management service 107 provides a billing statement view as presented to a user by way of a browser 601. As mentioned previously with respect to FIGS. 1A and 1B, the data management service 107 facilitates generation and presentment of the billing statement to reflect specific content, formatting, settings and even actionable content as requested by the user, service provider, operating system, or combination thereof. For example, a credit card services provider can generate the billing statement to include a graphic 603, positioned in a specific portion of the UI 601. The billing statement also includes user specific content detailing the charges applied to the credit card account 605. Customized content 607 is also featured, including a recommendation/analysis message alerting the user of potential savings they may receive by taking and/or initiating one or more actions (e.g., selecting the “Switch To Direct Debit”) action button 611.

Additional action buttons are also featured, including a “Pay Now” button 609 for enabling the user to initiate payment, a “Next Bill” button 613 for updating the screen to feature a billing statement for another service provider and an “Exit” button 615. It is noted that per the mapping process, the various content information 603-615 may or may not be in the same location as it appears on an initially loaded/sample document as provided to the ETL execution system 108. It is contemplated that other alternative and/or additional screens may also be provided, including those for facilitating document retrieval, archiving, organizing or the like.

In addition to the screen provided by browser 601, document management service 107, as a portal, can present various screens to provide all the functions and features. Screen 610, as shown in FIG. 6B, can effective serve as a home page that presents information about the service, and provides a user with the ability to register with the service.

The processes described herein for enabling the secure receipt, tracking, management and analysis of vital documents may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

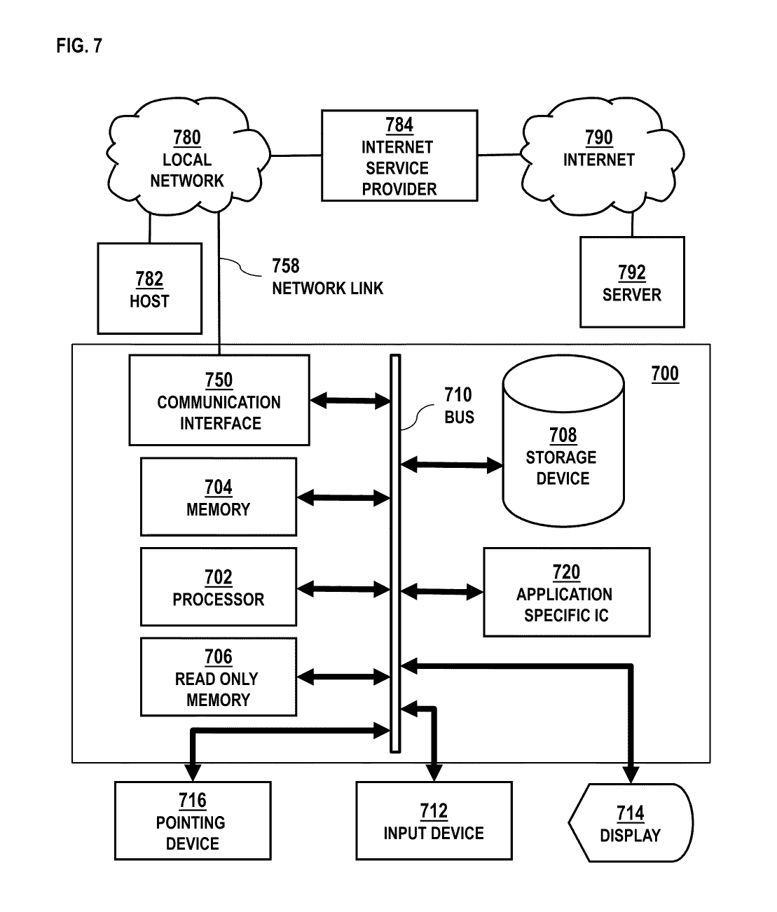

FIG. 7 illustrates a computer system upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) the processes for intelligently collecting and handling documentation as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of tagging media items based on spatiotemporal data.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code. The computer program code is a set of instructions or statements providing instructions for the operation of the processor 702 and/or the computer system 700 to perform specified functions. The code, for example, may be written in a computer programming language that is compiled into a native instruction set of the processor 702. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor 702 is represented to the processor 702 by information called instructions, such as an operation code of one or more digits. A sequence of operations to be executed by the processor 702, such as a sequence of operation codes, constitute processor instructions, also called computer system 700 instructions or, simply, computer instructions. Processors 702 may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions tagging media items based on spatiotemporal data. Dynamic memory 704 allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory 704 is composed of volatile storage that loses the information stored thereon when power is lost. Also coupled to bus 710 is a non-volatile (persistent) storage device 706, such as a magnetic disk, optical disk or flash card, for storing information, including instructions, that persists even when the computer system 700 is turned off or otherwise loses power.

Information, including instructions tagging media items based on spatiotemporal data, is provided to the bus 710 for use by the processor 702 from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs 720 include graphics accelerator cards for generating images for display, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface coupled to bus 710. Communication interface 750 provides a one-way or two-way communication coupling to a variety of external devices that operate with their own processors, such as printers, scanners and external disks. In general the coupling is with a network link that is connected to a local network to which a variety of external devices with their own processors are connected. For example, communication interface 750 may be a parallel port or a serial port or a universal serial bus (USB) port on a personal computer. In some embodiments, communications interface is an integrated services digital network (ISDN) card or a digital subscriber line (DSL) card or a telephone modem that provides an information communication connection to a corresponding type of telephone line. In some embodiments, a communication interface 750 is a cable modem that converts signals on bus 710 into signals for a communication connection over a coaxial cable or into optical signals for a communication connection over a fiber optic cable. As another example, communications interface may be a local area network (LAN) card to provide a data communication connection to a compatible LAN, such as Ethernet. Wireless links may also be implemented. For wireless links, the communications interface sends or receives or both sends and receives electrical, acoustic or electromagnetic signals, including infrared and optical signals, that carry information streams, such as digital data. For example, in wireless handheld devices, such as mobile telephones like cell phones, the communications interface includes a radio band electromagnetic transmitter and receiver called a radio transceiver. In certain embodiments, the communications interface enables connection to the communication network.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC.

Network link 758 typically provides information communication using transmission media through one or more networks to other devices that use or process the information. For example, network link may provide a connection through local network 780 to a host computer 782 or to equipment operated by an Internet Service Provider (ISP) 784. ISP equipment in turn provides data communication services through the public, world-wide packet-switching communication network of networks now commonly referred to as the Internet 790.

A computer called a server host 792 connected to the Internet 790 hosts a process that provides a service in response to information received over the Internet 790. For example, server host 792 hosts a process that provides information representing video data for presentation at display 714. It is contemplated that the components of system 700 can be deployed in various configurations within other computer systems, e.g., host and server.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device or network link. Execution of the sequences of instructions contained in memory 704 causes processor 702 to perform one or more of the method steps described herein. In alternative embodiments, hardware, such as ASIC, may be used in place of or in combination with software to implement the invention. Thus, embodiments of the invention are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host. The remote computer loads the instructions and data into its dynamic memory 704 and sends the instructions and data over a telephone line using a modem. A modem local to the computer system 700 receives the instructions and data on a telephone line and uses an infra-red transmitter to convert the instructions and data to a signal on an infra-red carrier wave serving as the network link. An infrared detector serving as communications interface receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device, either before or after execution by the processor 702.

Moreover, a chip set is programmed to perform the described processes and includes, for instance, the processor 702 and memory 704 components described with respect to FIG. 1A incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set, or a portion thereof, constitutes a means for performing one or more steps of tagging media items based on spatiotemporal data.

In one embodiment, the chip set includes a communication mechanism such as a bus 710 for passing information among the components of the chip set. A processor 702 has connectivity to the bus 710 to execute instructions and process information stored in, for example, a memory 704. The processor 702 may include one or more processing cores with each core configured to perform independently. A multi-core processor 702 enables multiprocessing within a single physical package. Examples of a multi-core processor 702 include two, four, eight, or greater numbers of processing cores. Alternatively or in addition, the processor 702 may include one or more microprocessors configured in tandem via the bus 710 to enable independent execution of instructions, pipelining, and multithreading. The processor 702 may also be accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 702. Similarly, an ASIC can be configured to performed specialized functions not easily performed by a general purposed processor 702. Other specialized components to aid in performing the inventive functions described herein include one or more field programmable gate arrays (FPGA) (not shown), one or more controllers (not shown), or one or more other special-purpose computer chips.

The processor 702 and accompanying components have connectivity to the memory 704 via the bus 710. The memory 704 includes both dynamic memory (e.g., RAM, magnetic disk, writable optical disk, etc.) and static memory (e.g., ROM, CD-ROM, etc.) for storing executable instructions that when executed perform the inventive steps described herein. The memory 704 also stores the data associated with or generated by the execution of the inventive steps.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting, via a browser application, document information associated with one of a plurality of user accounts, wherein the document information includes a digital scan of a physical document or an image;
storing the collected document information in a cloud-based filing system configured to store a plurality of document information for the respective user accounts; and
selectively initiating one or more actions based on the collected document information for the one user account.

2. A method according to claim 1, wherein the actions include a payment transaction, the method further comprising:
extracting billing information from the document information; and
transmitting the billing information to a payment service provider system for execution of the payment transaction.

3. A method according to claim 1, wherein the collected document information has a first format, the method further comprising:
transforming the document information into data having a second format that is common with the other document information of the other user accounts.

4. A method according to claim 3, wherein the transformation is performed via a mapping user interface that maps a plurality of source fields into a plurality of target fields, the source fields including a document header field and a document body field.

5. A method according to claim 4, further comprising:
generating one or more transformation rules associated with the mapping; and
creating a transformation file to execute the transformation rules.

6. A method according to claim 3, further comprising:
presenting the data via a graphical user interface according to the second format.

7. A method according to claim 6, wherein the second format includes an extensible mark-up language (XML) format.

8. An apparatus comprising:
a processor configured to collect, via a browser application, document information associated with one of a plurality of user accounts, wherein the document information includes a digital scan of a physical document or an image; and
a memory coupled to the processor and configured to store the collected document information in a cloud-based filing system configured to store a plurality of document information for the respective user accounts,
wherein the processor is further configured to selectively initiate one or more actions based on the collected document information for the one user account.

9. An apparatus according to claim 8, wherein the actions include a payment transaction, and the processor is further configured to cause the apparatus to:
extract billing information from the document information, and
transmit the billing information to a payment service provider system for execution of the payment transaction.

10. An apparatus according to claim 8, wherein the collected document information has a first format, and the processor is further configured to cause the apparatus to:
transform the document information into data having a second format that is common with the other document information of the other user accounts.

11. An apparatus according to claim 10, wherein the transformation is performed via a mapping user interface that maps a plurality of source fields into a plurality of target fields, the source fields include a document header field and a document body field.

12. An apparatus according to claim 11, wherein the processor is further configured to cause the apparatus to:
generate one or more transformation rules associated with the mapping; and
create a transformation file to execute the transformation rules.

13. An apparatus according to claim 10, wherein the processor is further configured to cause the apparatus to:
present the data via a graphical user interface according to the second format.

14. An apparatus according to claim 13, wherein the second format includes an extensible mark-up language (XML) format.

15. A system comprising:
a service bus configured to collect, via a browser application, document information associated with one of a plurality of user accounts, wherein the document information includes a digital scan of a physical document; and
a data store coupled to the service bus and configured to store the collected document information in a cloud-based filing system configured to store a plurality of document information for the respective user accounts,
wherein one or more actions are selectively initiated based on the collected document information for the one user account.

16. A system according to claim 15, wherein the actions include a payment transaction, the system further comprising:
a billing module coupled to the service bus and configured to extract billing information from the document information, and to transmit the billing information to a payment service provider system for execution of the payment transaction.

17. A system according to claim 15, wherein the collected document information has a first format, the system further comprising:
a transformation module coupled to the service bus and configured to transform the document information into data having a second format that is common with the other document information of the other user accounts.

18. A system according to claim 17, wherein the transformation is performed using a mapping user interface that maps a plurality of source fields into a plurality of target fields, the source fields include a document header field and a document body field.

19. A system according to claim 18, wherein the transformation module is further configured to generate one or more transformation rules associated with the mapping, and to create a transformation file to execute the transformation rules.

20. A system according to claim 17, further comprising:
a presentation module configured to present the data via a graphical user interface according to the second format, wherein the second format includes an extensible mark-up language (XML) format.
